(19) United States
(12) Patent Application Publication
(10) Pub. No.: US 2022/0378006 A1
(43) Pub. Date: Dec. 1, 2022

(54) PRESS COVER

(71) Applicant: Kalt Maschinenbau AG, Lütisburg (CH)

(72) Inventors: Marcel Müller, Wil (CH); Samuel Rüegg, Lütisburg (CH)

(73) Assignee: Kalt Maschinenbau AG, Lütisburg (CH)

(21) Appl. No.: 17/825,253

(22) Filed: May 26, 2022

(30) Foreign Application Priority Data
May 27, 2021 (CH) 00599/21
Oct. 28, 2021 (CH) 070464/2021

(51) Int. Cl. A01J 25/15; A01J 25/13

(52) U.S. Cl. CPC A01J 25/15; A01J 25/13

(57) ABSTRACT

A press cover, which corresponds with a cheese mould, in particular a cheese mould which is arranged in a cassette press or suchlike. It is to be of simple construction, to withstand a pressing force and also to meet high hygiene requirements. The press cover has a one-walled perforated plate in the form of a perforated sheet, which is provided with perforations, and which has a straight rim or a circumferential, bent rim.

### FIELD OF THE INVENTION

The invention relates to a press cover which corresponds with a cheese mould, in particular a cheese mould which is arranged in a cassette press or suchlike.

### BACKGROUND

A device for the industrial production of loaves of cheese is known e.g. from EP-A-350777. This comprises a filling press with a trough which is rectangular and is open at the top, for receiving moulds, a column frame for arranging a press head which is able to be raised and lowered, and a distributing head for the delivering and metering of the raw cheese material into the moulds, and a gantry carriage, movable on the trough, for guiding the distributing head and for handling a turning mechanism for the moulds. The distributing head as well as the turning mechanism must be provided or respectively changed manually here. The wall of the mould consists of a perforated sheet and several moulds can be arranged in sets. Cylindrical pins for the docking of a handling device are provided at the end faces of a set.

EP-A-406899 shows a further development of such a device, in which the moulds are received in cassettes which, in turn, are arranged in a compact manner and in rows in the trough. A press head with press dies aligned to the moulds, for pressing the raw cheese material, is provided above the moulds.

The actual press mould is surrounded here by a pot-shaped casing with an air supply duct (EP-B-1269832). Thereby, an air duct is formed and, after pressing, the cheese material adhering to the screen holes of the perforated sheet of the mould can be detached from the pressing hoop side by the air which is delivered.

According to EP-B-543185 a mould cover or respectively press cover is able to be connected (in a self-centring manner) to the press die via a tilting device, so that as a result of possible tilting movements a suction of the mould cover to the cheese material is prevented. The mould itself is round or four-sided and can consist of an outer container and of an inner, perforating casing.

BR 9300409 discloses a mould with a double wall which is provided with ribs crossing at its base. These ribs serve, however, only as a stop of a base sheet and are unsuitable as reinforcing elements and are also not provided for this.

In U.S. Pat. No. 3,838,955A a mould for the production of cheddar is disclosed, which has a mould and a press cover. The mould and, in particular the press cover, are embodied in a solid manner. The press cover and the base of the mould are provided with a few holes 5 for the outflow of whey.

The press cover is constructed in a plate-like manner and consists of PP or PE. It is provided with an elevated, solid flange which has eyelets for hanging. The plate-like press cover is provided with a second, substantially thinner, perforated plate, facing the mould, for whey discharge of the cheese material. To achieve the necessary dimensional stability during the pressing out of whey, such plate-like press covers made of plastic have a thickness of ca. 10 mm.

A further cheese mould with a perforated mould wall made of metal is disclosed in DE-B-1030612. This mould wall has, on its inner surface, uniformly distributed, low elevations and depressions of up to ca. 1 mm, which are intended not to damage the cheese rind on removal of the loaf of cheese, even if the cheese is knocked out of the mould. According to DE-C-2823182, such a cheese mould with a perforated wall can also consist of plastic, on the inner side of which grooves, parallel to one another, having a triangular cross-section, are provided. In the transition- and one-part base region, the grooves are separated by ribs with interruptions. Such mould walls or double bases are laborious to clean.

In EP 2710889 A1 a press cover is disclosed, which is formed from a perforated sheet with a reinforcing rib structure, situated thereon, made from a stainless steel. The rib structure is non-detachably connected, in particular welded, to the perforated sheet on thin webs.

EP 3501269 B1 shows a further press cover made from a plastic. The press cover comprises substantially a one-part perforated plate made from a plastic, the cross-section of which corresponds to the interior cross-section of a cheese mould, with which the press cover corresponds in conventional use, with a rib structure formed thereon, which gives the press cover the necessary dimensional stability and rigidity.

The press cover is produced in one piece, for example by milling out from a plate or in 3D printing. This press cover enables a good whey discharge but, because of the ribbing, is comparatively expensive to produce and laborious to clean.

### SUMMARY

One aspect of the invention relates to a press cover which corresponds with a cheese mould and which is suitable for arranging on the press head of a cassette press or suchlike, which is simple in construction, withstands a pressing force and also meets high hygiene requirements.

In an embodiment, a press cover according to the invention comprises substantially a single-walled perforated plate, the cross-section of which corresponds to the interior cross-section of a cheese mould, with which the press cover corresponds in conventional use. The perforated plate is a perforated sheet made of metal, in particular steel, and has a plurality of perforations for the discharge of pressed-out whey. The perforated sheet further comprises a circumferential, bent rim, which is bent in the pressing direction. The rim gives the press cover a high dimensional stability and rigidity. The perforated sheet can also be provided with a straight rim.

The perforated sheet of the press cover is produced in one piece, for example by deep-drawing.

The press cover according to the invention enables on the one hand a good whey discharge and on the other hand is able to be cleaned easily and completely from both sides.

The press cover offers a high degree of food safety and hygiene and is able to be cleaned easily. Splinterings, as are possible in the case of plastic, do not occur.

It has a long service life, is dimensionally stable, rigid, and is able to be produced in an automated and process-reliable and also economical manner.

Preferred embodiments are disclosed herein.

The perforated sheet of the press cover is provided with a perforation, except for the regions around hooks which are arranged on the side of the perforated sheet facing away from the rim. Preferably there are three hooks which are arranged spaced uniformly apart from one another along a press ring. The hooks serve to receive the press cover on a press head of a cheese press and they have, in addition, a guiding function. They direct the press frame onto the perforated sheet surface. The pressing force is transferred three to the raw cheese material which is to be pressed out.

The hole diameter of the perforation is preferably 0.6-1.2 mm. Smaller hole diameters are less able to be cleaned well. The individual holes are arranged with a distance of a few millimetres, preferably 2-3 mm, from one another.

The perforation is preferably embodied in the form of cylindrical, conical or stepped bores.

The press cover according to the invention can be embodied with any desired cross-section, in particular a round or four-sided cross-section. However, special shapes would also be possible, such as for example a heart-shaped cross-section.

Such a shaping, material selection and production method does not result obviously from the prior art.

A cheese mould has a base and side walls, wherein the base and the side walls are formed substantially from the previously described perforated sheet and that the cheese mould is round or respectively cylindrical or polygonal.

At least two polygonal, preferably four-sided, cheese moulds are preferably arranged combined as a cassette, wherein the cheese moulds are connected by means of a cover sheet and transverse ribs arranged close to the base. For reinforcement, the cassette which is thus formed has, in addition, longitudinal ribs on the base and/or casing ribs in the region of the outer side walls, which are respectively preferably arranged parallel to one another.

### BRIEF DESCRIPTION OF THE DRAWINGS

The invention is described more closely below in an example embodiment. In the drawings there are shown:

FIG. 1: a press cover according to the invention, round;

FIG. 2: the press cover according to FIG. 1 in detail view;

FIG. 3: the press cover according to FIG. 1 in top view;

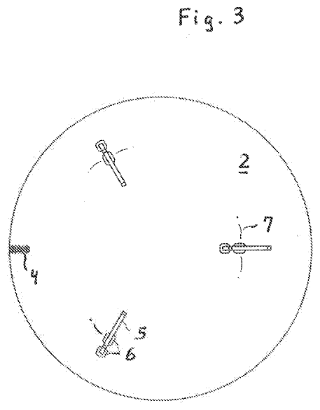

FIG. 4: a press cover in a different embodiment;

FIG. 5: the press cover according to FIG. 4 in detail view;

FIG. 6: the press cover according to the invention, four-sided;

FIG. 7: a rectangular cheese mould;

FIG. 8: the cheese mould according to FIG. 7 in a different view and

FIG. 9: a perforated sheet according to the invention.

### DETAILED DESCRIPTION

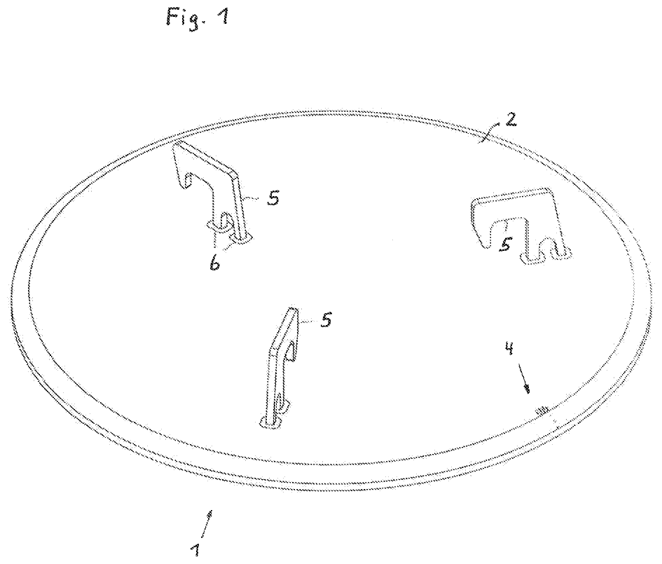

A press cover 1 according to the invention (FIG. 1), in the example for a round cheese mould (not illustrated), comprises a one-walled, circular perforated sheet 2, which in its cross-section corresponds to the interior cross-section of the cheese mould (likewise circular). The perforated sheet 2 is polished at least on the side facing the pressing direction.

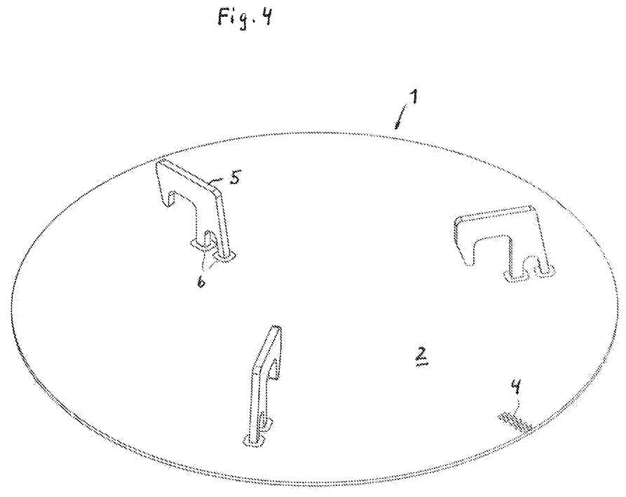

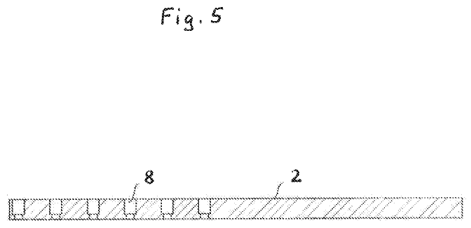

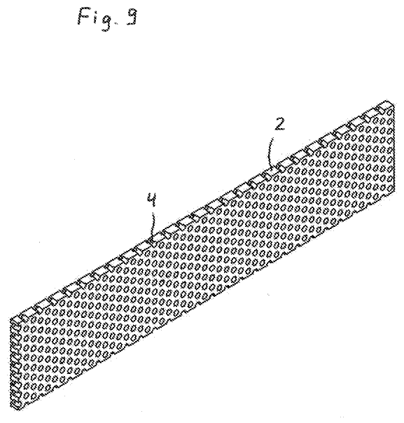

The perforated sheet 2 has a plurality of perforations 4 (FIG. 9) and, in the example, a circumferential, bent rim 3 of for example a height h of 10 mm and a radius r of ca. 8 mm. The rim 3 is bent in pressing direction 9 and, on the pressing out of whey, lying closely against the inner wall of the cheese mould. In another embodiment, the perforated sheet 2 can also be provided with a straight rim (FIGS. 4 and 5).

Such a perforated sheet 2 is able to be produced economically by means of deep-drawing.

On the perforated sheet 2, with a round formation of the press cover 1, three hooks 5 are arranged, spaced apart from one another uniformly along a (virtual) press ring 7, on the side facing away from the pressing direction or respectively the cheese mould (FIG. 1, 3).

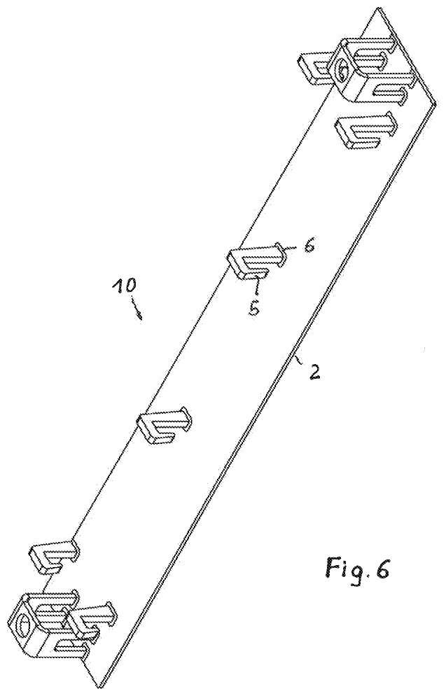

With a four-sided press cover 10 (FIG. 6), the hooks 5 in the example are arranged both centrally along a longitudinal axis of the press cover 10 and also, close to the narrow sides, to the left and right adjacent to the longitudinal axis.

The hooks 5 serve in a known manner for receiving the press cover 1 on a press head of a cheese press and direct the press frame onto the perforated sheet surface.

A region 6 around the hooks 5 is free of holes.

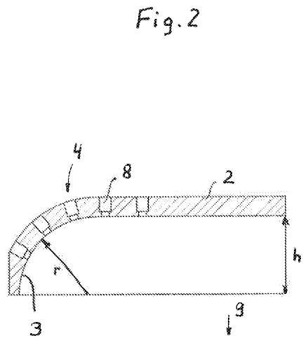

In the example, the perforations 4 are embodied as stepped bores 8 (FIG. 2, 9). In the example, the larger hole diameter is preferably 1.2 mm and the smaller hole diameter 0.8 mm. Smaller hole diameters are less well able to be cleaned. The individual bores 8 are arranged at a distance of a few millimetres, preferably 2-3 mm, from one another.

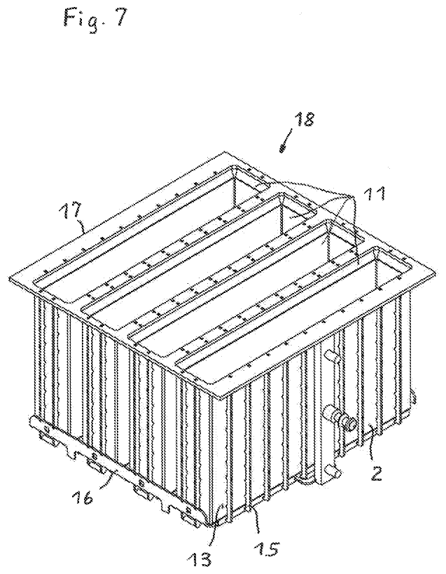

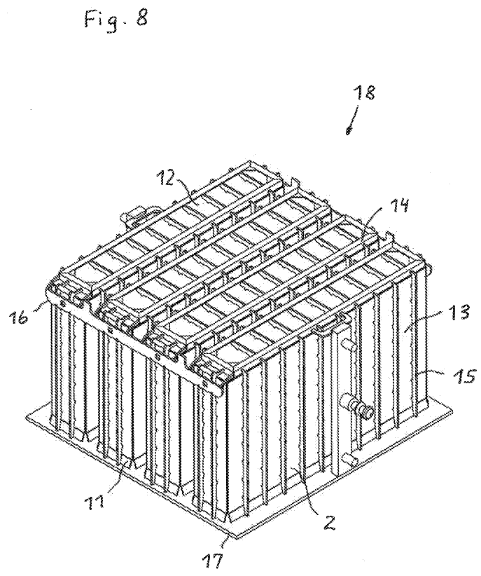

FIGS. 7 and 8 show a four-sided, cuboidal cheese mould 11, which has a base 12 and side walls 13, wherein the base 12 and the side walls 13 are formed from the previously described perforated sheet 2.

In the example, in addition, four of these cheese moulds 11 are arranged together as a cassette 18, wherein the cheese moulds 11 are connected by means of a cover sheet 17 and transverse ribs 16 arranged close to the base. In the example, the transverse ribs 16 are arranged on two outer side walls standing parallel to one another. The cassette 18 which is thus formed has furthermore, for reinforcement, longitudinal ribs 14 on the base and casing ribs 15 in the region of the side walls, which are respectively arranged parallel to one another.

A further round cheese mould in a cheese press, with which the press cover 1 according to the invention corresponds, is disclosed for example in the applicant's EP 2845469 A1. It comprises a cylindrical casing with an upper basket and a base.

For cheese which is to be high-pressed, i.e. hard cheese, the casing wall and also the base consist of perforated sheet. In the pressing out of soft cheese or semi-hard cheese, on the other hand, a conventional perforation can be sufficient.

### LIST OF REFERENCE NUMBERS

1 press cover

2 perforated sheet

3 rim

4 perforation

5 hook

6 region

7 press ring

8 bore

9 pressing direction

10 press cover

11 cheese mould

12 base

13 side wall

14 longitudinal rib

15 casing rib

16 transverse rib

17 cover sheet

18 cassette

h height

r radius

1. A press cover of a cheese mould, wherein the press cover has a cross-section corresponding to an interior cross-section of the cheese mould and has a one-walled perforated plate, which is provided with a plurality of perforations, wherein the perforated plate is a perforated sheet made of metal and has a straight rim or a circumferential bent rim.

2. The press cover according to claim 1, wherein press cover is made of steel.

3. The press cover according to claim 1, wherein the steel is a stainless steel.

4. The press cover according to claim 1, wherein on the perforated sheet side facing away from the rim at least three hooks are arranged along a press ring or close to a longitudinal axis.

5. The press cover according to claim 4, wherein the perforations are provided on the perforated sheet except for regions in which the at least three hooks are arranged.

6. The press cover according to claim 1, wherein the perforations are in the form of cylindrical, conical or stepped bores.

7. The press cover according to claim 1, wherein each of the perforations has a hole diameter of 0.6-1.2 mm and wherein the perforations are arranged at a distance of 2-3 mm from one another.

8. The press cover according to claim 1, wherein the perforated sheet has a height of the rim of 8-10 mm.

9. A combination comprising the press cover according to claim 1 and a cheese mould, wherein the cheese mould has a base and side walls, and wherein the cheese mould is round or respectively cylindrical or polygonal.

10. The combination according to claim 9, wherein at least two polygonal cheese moulds are arranged as a cassette, the cheese moulds connected by means of a cover sheet and transverse ribs arranged close to the base, and wherein the cassette further has longitudinal ribs on the base and/or casing ribs in the region of the side walls.

11. A method for the production of a press cover for a cheese mould which consists of metal and comprises a one-walled perforated plate, wherein the perforated plate is produced in the form of a perforated sheet with a circumferential, bent rim by deep-drawing, into which subsequently a plurality of perforations are worked in.
